(19) United States
(12) Patent Application Publication
(10) Pub. No.: US 2021/0367830 A1
(43) Pub. Date: Nov. 25, 2021

(54) DYNAMIC EVENT PROCESSING FOR NETWORK DIAGNOSIS

(71) Applicant: VMware, Inc., Palo Alto, CA (US)

(72) Inventors: Jayant JAIN, Cupertino, CA (US); Sushruth GOPAL, Sunnyvale, CA (US); Russell LU, Pleasanton, CA (US); Anirban SENGUPTA, Saratoga, CA (US); Yangyang ZHU, Mountain View, CA (US)

(73) Assignee: VMware, Inc., Palo Alto, CA (US)

(21) Appl. No.: 16/879,796

(22) Filed: May 21, 2020

(51) Int. Cl. H04L 12/24; H04L 12/26; G06F 9/455

(52) U.S. Cl. CPC H04L 41/0627; H04L 41/0645; G06F 2009/45595; H04L 43/0817; G06F 9/45558; H04L 41/0613

(57) ABSTRACT

Example methods and systems for dynamic event processing for network diagnosis are described. In one example, a computer system may monitor a runtime flow of multiple packets to detect a set of multiple events associated with the runtime flow. The computer system may perform a first stage of event processing by matching the set of multiple events to a set of multiple signatures that includes a first signature and a second signature. The first signature may be associated with a first mapping rule that is fully satisfied by the set of multiple events. The second signature may be associated with a second mapping rule that is partially satisfied. During a second stage of event processing, the second signature is disregarded. In response to diagnosing an issue associated with the runtime flow, remediation action(s) may be performed.

Virtualization allows the abstraction and pooling of hardware resources to support virtual machines in a Software-Defined Networking (SDN) environment, such as a Software-Defined Data Center (SDDC). For example, through server virtualization, virtualization computing instances such as virtual machines (VMs) running different operating systems may be supported by the same physical machine (e.g., referred to as a “host”). Each VM is generally provisioned with virtual resources to run an operating system and applications. The virtual resources may include central processing unit (CPU) resources, memory resources, storage resources, network resources, etc. In practice, traffic among VMs may be susceptible to various network issues, which may affect the performance of hosts and VMs.

### BRIEF DESCRIPTION OF DRAWINGS

FIG. 1 is a schematic diagram illustrating an example software-defined networking (SDN) environment in which dynamic event processing for network diagnosis may be performed;

FIG. 2 is a flowchart of an example process for a computer system to perform dynamic event processing for network diagnosis;

FIG. 3 is a schematic diagram of an example event mapping rule generation to facilitate dynamic event processing;

FIG. 4 is a flowchart of an example detailed process for a computer system to perform dynamic event processing for network diagnosis;

FIG. 5 is a schematic diagram illustrating a first example of dynamic event processing for network diagnosis; and

FIG. 6 is a schematic diagram illustrating a second example of dynamic event processing for network diagnosis.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first,” “second” and so on are used to describe various elements, these elements should not be limited by these terms. These terms are used to distinguish one element from another. A first element may be referred to as a second element, and vice versa.

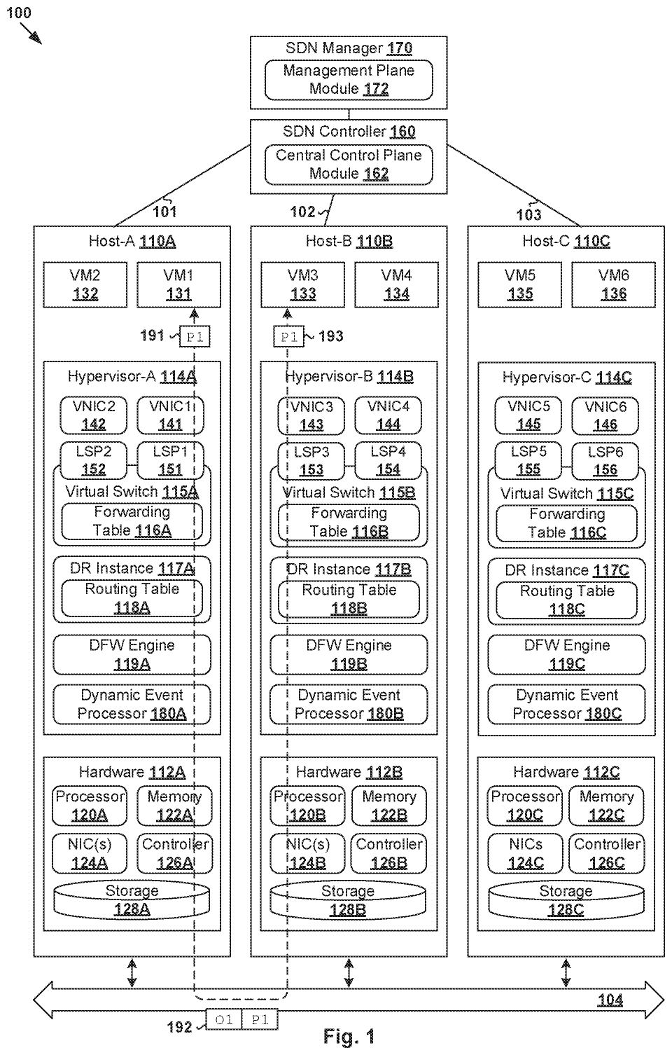

Challenges relating to network diagnosis will now be explained in more detail using FIG. 1, which is a schematic diagram illustrating example software-defined networking (SDN) environment 100 in which dynamic event processing for network diagnosis may be performed. Depending on the desired implementation, SDN environment 100 may include additional and/or alternative components than that shown in FIG. 1. SDN environment 100 includes multiple hosts, such as host-A 110A, host-B 110B and host-C 110C that are inter-connected via physical network 104. In practice, SDN environment 100 may include any number of hosts (also known as a “host computers”, “host devices”, “physical servers”, “server systems”, “transport nodes,” etc.), where each host may be supporting tens or hundreds of VMs.

Each host 110A/110B/110C may include suitable hardware 112A/112B/112C and virtualization software (e.g., hypervisor-A 114A, hypervisor-B 114B, hypervisor-C 114C) to support various virtual machines (VMs) 131-136. For example, host-A 110A supports VM1 131 and VM2 132; host-B 110B supports VM3 133 and VM4 134; and host-C 110C supports VM5 135 VM6 136. Hypervisor 114A/114B/114C maintains a mapping between underlying hardware 112A/112B/112C and virtual resources allocated to respective VMs 131-136. Hardware 112A/112B/112C includes suitable physical components, such as central processing unit(s) (CPU(s)) or processor(s) 120A/120B/120C; memory 122A/122B/122C; physical network interface controllers (NICs) 124A/124B/124C; storage controller 126A/126B/126C; and storage disk(s) 128A/128B/128C, etc.

Virtual resources are allocated to respective VMs 131-136 to support a guest operating system (OS) and application(s). For example, the virtual resources may include virtual CPU, guest physical memory, virtual disk, virtual network interface controller (VNIC), etc. Hardware resources may be emulated using virtual machine monitors (VMMs). For example in FIG. 1, VNICs 141-146 are emulated by corresponding VMMs (not shown for simplicity). The VMMs may be considered as part of respective VMs 131-136, or alternatively, separated from VMs 131-136. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 114A-C may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” may refer generally to multiple packets. The term “layer-2” may refer generally to a link layer or Media Access Control (MAC) layer; “layer-3” to a network or Internet Protocol (IP) layer; and “layer-4” to a transport layer (e.g., using Transmission Control Protocol (TCP), User Datagram Protocol (UDP), etc.), in the Open System Interconnection (OSI) model, although the concepts described herein may be used with other networking models.

Hypervisor 114A/114B/114C implements virtual switch 115A/115B/115C and logical distributed router (DR) instance 117A/117B/117C to handle egress packets from, and ingress packets to, corresponding VMs 131-136. In SDN environment 100, logical switches and logical DRs may be implemented in a distributed manner and can span multiple hosts to connect VMs 131-136. For example, logical switches that provide logical layer-2 connectivity may be implemented collectively by virtual switches 115A-C and represented internally using forwarding tables 116A-C at respective virtual switches 115A-C. Forwarding tables 116A-C may each include entries that collectively implement the respective logical switches. Further, logical DRs that provide logical layer-3 connectivity may be implemented collectively by DR instances 117A-C and represented internally using routing tables 118A-C at respective DR instances 117A-C. Routing tables 118A-C may each include entries that collectively implement the respective logical DRs.

Packets may be received from, or sent to, each VM via an associated logical switch port. For example, logical switch ports 151-156 (labelled “LSP1” to “LSP6”) are associated with respective VMs 131-136. Here, the term “logical port” or “logical switch port” may refer generally to a port on a logical switch to which a virtualized computing instance is connected. A “logical switch” may refer generally to a software-defined networking (SDN) construct that is collectively implemented by virtual switches 115A-C in the example in FIG. 1, whereas a “virtual switch” may refer generally to a software switch or software implementation of a physical switch. In practice, there is usually a one-to-one mapping between a logical port on a logical switch and a virtual port on virtual switch 115A/115B/115C. However, the mapping may change in some scenarios, such as when the logical port is mapped to a different virtual port on a different virtual switch after migration of the corresponding VM (e.g., when the source host and destination host do not have a distributed virtual switch spanning them).

SDN manager 170 and SDN controller 160 are example network management entities in SDN environment 100. To send and receive the control information, each host 110A/110B/110C may implement local control plane (LCP) agent (not shown) to interact with SDN controller 160. For example, control-plane channel 101/102/103 may be established between SDN controller 160 and host 110A/110B/110C using TCP over Secure Sockets Layer (SSL), etc. Management entity 160/170 may be implemented using physical machine(s), virtual machine(s), a combination thereof, etc. Hosts 110A-C may also maintain data-plane connectivity with each other via physical network 104.

Through virtualization of networking services in SDN environment 100, logical overlay networks may be provisioned, changed, stored, deleted and restored programmatically without having to reconfigure the underlying physical hardware architecture. A logical overlay network (also known as “logical network”) may be formed using any suitable tunneling protocol, such as Generic Network Virtualization Encapsulation (GENEVE), Virtual eXtensible Local Area Network (VXLAN), Stateless Transport Tunneling (STT), etc. For example, tunnel encapsulation may be implemented according to a tunneling protocol to extend layer-2 segments across multiple hosts. In relation to a logical overlay network, the term “tunnel” may refer generally to a tunnel established between a pair of VTEPs over physical network 104, over which respective hosts are in layer-3 connectivity with one another.

Hypervisor 114A/114B/114C may implement a virtual tunnel endpoint (VTEP) to encapsulate and decapsulate packets with an outer header (also known as a tunnel header) identifying a logical overlay network (e.g., VNI=5000) to facilitate communication over the logical overlay network. For example, hypervisor-A 114A implements a first VTEP-A associated with (IP address=IP-A, MAC address=MAC-A, VTEP label=VTEP-A), hypervisor-B 114B a second VTEP-B with (IP-B, MAC-B, VTEP-B) and hypervisor-C 114C a third VTEP-C with (IP-C, MAC-C, VTEP-C). Encapsulated packets may be sent via a logical overlay tunnel established between a pair of VTEPs over physical network 104. In practice, a host may support more than one VTEP.

To protect VMs 131-136 against security threats caused by unwanted packets, hypervisor 114A/114B/114C may implement distributed firewall (DFW) engine 119A/119B/119C to filter packets to and from associated VMs. For example, at host-A 110A, hypervisor 114A implements DFW engine 119A to filter packets for VM1 131 and VM2 132. SDN controller 180 may be used to configure firewall rules that are enforceable by DFW engine 119A/119B/119C. In practice, network packets may be filtered according to firewall rules at any point along the datapath from a source (e.g., VM1 131) to a physical NIC (e.g., 124A). In one embodiment, a filter component (not shown) may be incorporated into each VNIC 141-144 to enforce firewall rules that are associated with the VM (e.g., VM1 131) corresponding to that VNIC (e.g., VNIC 141). The filter components may be maintained by DFW engines 119A-C.

In practice, network diagnosis may be implemented to identify various issues in SDN environment 100, such as security threats, misuses, invalid configurations or performance issues. One approach is to monitor for network events that provide an insight into how well a network or a workload is performing. Conventionally, information relating network events is often sent to a database to facilitate subsequent retrieval using a query language such as structured query language (SQL). In other network diagnosis approaches, fixed queries may be made against streaming data for analysis. Such conventional approaches usually lack effectiveness, such as due to the time lag between event detection and subsequent analysis. This may in turn expose hosts 110A-C and VMs 131-136 to security and performance risks.

Dynamic Event Processing for Network Diagnosis

According to examples of the present disclosure, dynamic event processing may be implemented to monitor packet flows at runtime. Examples of the present disclosure may be implemented for detecting events and analyzing them dynamically so that remediation action(s) may be performed substantially close to the time at which the events were detected. As used herein, the term “dynamic” may refer generally to the execution of event processing in real time or near real time. A related term is “runtime,” which may refer generally to a period of time during which a monitoring target (e.g., packet flow) is active. The term “dynamic” may also refer generally to the adaptive execution of event processing based on any suitable configuration of events, rules and signatures (to be discussed below). Such dynamic approach should be contrasted against conventional approaches using fixed queries, which are usually non-modifiable and rely on some static events.

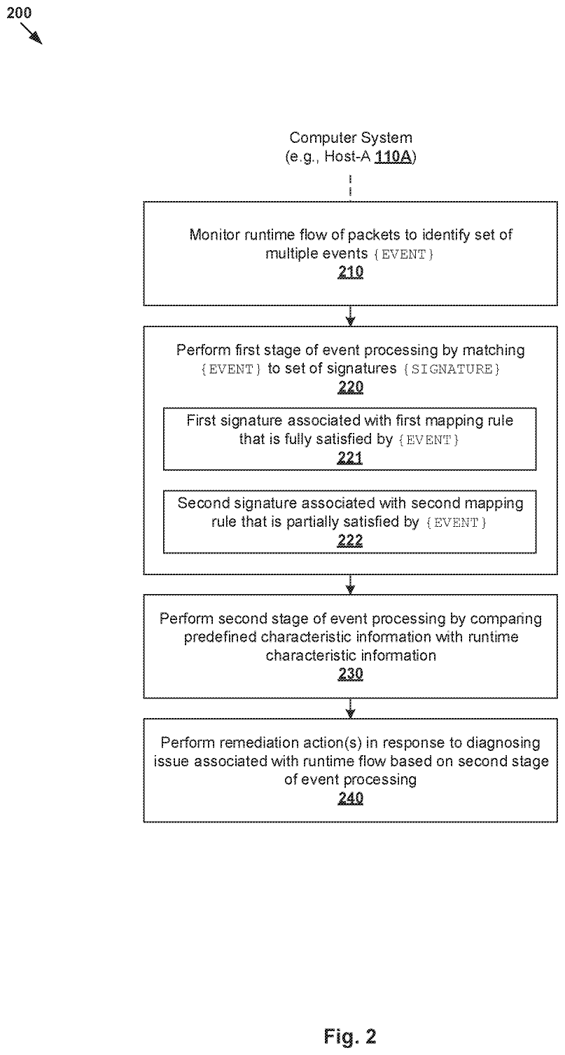

In more detail, FIG. 2 is a flowchart of example process 200 for a computer system to perform dynamic event processing for network diagnosis. Example process 200 may include one or more operations, functions, or actions illustrated by one or more blocks, such as 210 to 240. The various blocks may be combined into fewer blocks, divided into additional blocks, and/or eliminated depending on the desired implementation. In practice, examples of the present disclosure may be implemented by any suitable “computer system,” such as host 110A/110B/110C using dynamic event processor 180A/180B/180C supported by hypervisor 114A/114B/114C. In the following, various examples will be discussed using host-A 110A as an example “computer system,” VM1 131 as a first virtualized computing instance and VM3 133 as a second virtualized computing instance.

At 210 in FIG. 2, host-A 110A may monitor a runtime flow of multiple packets that originate from, or destined for, VM1 131 to identify a set of multiple events associated with the runtime flow. In the example in FIG. 1, VM1 131 supported by host-A 110A may be communicating with VM3 133 supported by host-B 110B. From the perspective of host-A 110A, an egress packet (P1) that is addressed from source VM1 131 to destination VM3 133 may be encapsulated with an outer header (O1) for transmission towards host-B 110B, which performs decapsulation and forwards the packet to VM3 133. See 191-193 in FIG. 1.

As used herein, the term “event” may refer generally to an incident of interest associated with the runtime flow. The term “signature” may refer generally to pattern(s) of interest that may be derived from the set of multiple events. As network flows are created and terminated dynamically, multiple events may be associated with these flows during the lifetime of the flows. In practice, any suitable events may be detected for network diagnosis purposes, ranging from simple events (e.g., failed TCP handshake) to more complex ones (e.g., a variety of destinations in a connection). For example, block 230 may involve using a set of event maps to match the set of multiple events to the set of signatures in a more efficient manner.

At 220 in FIG. 2, host-A 110A may perform a first stage of event processing by matching the set of multiple events to a set of multiple signatures that includes (a) a first signature and (b) a second signature. The first signature (see 221) may be associated with a first mapping rule that is fully satisfied by the set of multiple events. The second signature (see 222) may be associated with a second mapping rule that is partially satisfied by the set of multiple events. Depending on desired implementation, the a “mapping rule” (also known as an “event map”) may be defined using logical operator(s) to test whether the mapping rule is fully satisfied (e.g., full match) or partially satisfied (e.g., partial match).

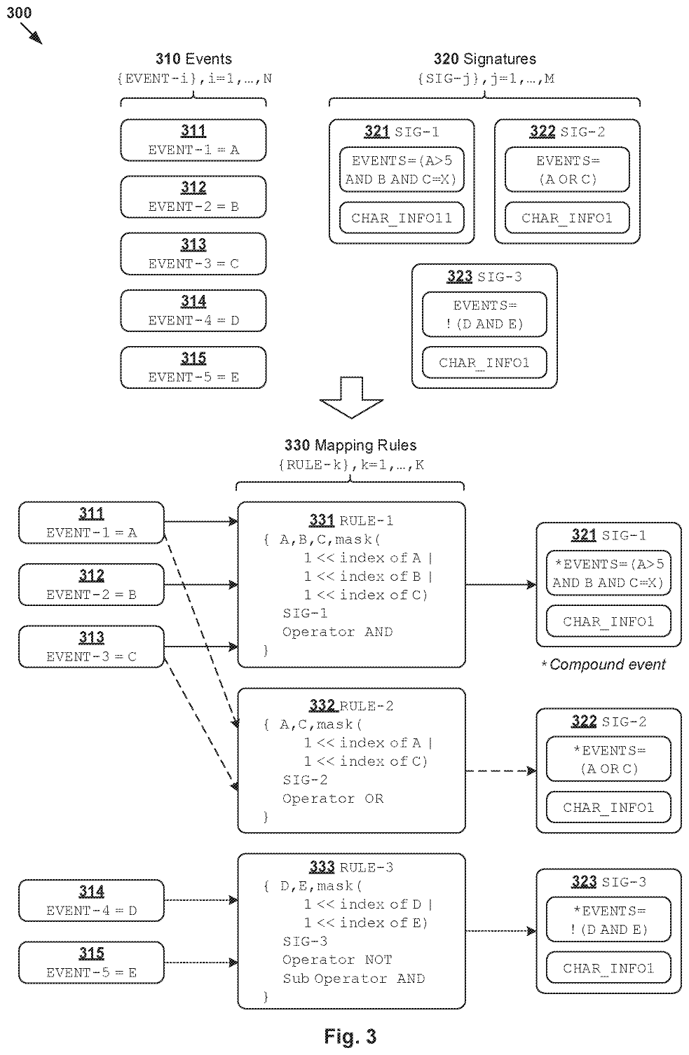

As will be explained using FIGS. 3-6 below, a mapping rule may be configured to determine whether a compound event has occurred using any suitable logical operators, such as AND, OR, XOR, NOT, NAND (i.e., NOT AND), NXOR (i.e., NOT XOR), etc. In practice, a compound event may be expressed as a logical combination of at least two events, such as (event A AND event B, (event A OR event C), etc. In this case, the first mapping rule may be fully satisfied in response to determination that a first compound event has occurred. The second mapping rule may be partially satisfied in response to determination that a second compound event has not occurred or partially occurred.

At 230, host-A 110A may perform a second stage of event processing by comparing (a) predefined characteristic information specified by the first signature against (b) runtime characteristic information associated with the runtime flow. The second signature may be disregarded or eliminated from further processing during the second stage. At 240, in response to detecting an issue based on the second stage of event processing, remediation action(s) may be performed. Any suitable “issue” may be detected at block 240, such as a security-related issue to support intrusion detection and/or prevention, a performance-related issue to facilitate resource optimization, etc.

According examples of the present disclosure, the second signature (i.e., a partial match) may be eliminated from the second stage of dynamic event processing. Since the second stage involves comparison of characteristic information and usually takes up the bulk of the processing time, dynamic event processing may be performed in a more efficient manner. Depending on the desired implementation, examples of the present disclosure may be implemented to facilitate large-scale, compound event processing in a real-time manner.

Dynamic Rule Configuration

According to examples of the present disclosure, mapping rules may be configured to process events in a more efficient manner. Each mapping rule may specify any suitable match fields to match a set of events to a signature. Some examples will be explained using FIG. 3, which is a schematic diagram illustrating example event map generation to facilitate dynamic event processing.

At 310 in FIG. 3, host 110A may configure a set of multiple (N) events that are detectable at runtime. The set may be represented as {EVENT-i}, where i=1, . . . , N. Using N=5 in FIG. 3, the set is denoted as {A, B, C, D, E, F}, where EVENT-1=A for i=1 (see 311), EVENT-1=B for i=2 (see 312), and so on (see 313-315). Note that index i may start at zero instead of one. Any suitable events may be defined or configured, from simple events to more complex ones. Example simple events may include failed TCP handshake, malicious packets, fragmented packets, drop rule hit at DFW engine 119A/119B/119C, secure shell (SSH) login failure, etc. More complex events may include detecting a variety of destinations in a connection, application IDs in a flow, detection of a series of connections (e.g., A followed by B), etc. One example complex event associated with a distributed denial of service (DDOS) attack may be detected based on connection requests to and/or from multiple hosts. In another example, a complex event may be detected based on server login attempts from different IP addresses (e.g., to avoid source-based restriction) or port scans from multiple IP addresses.

At 320 in FIG. 3, host 110A may configure a set of multiple (M) signatures that may be matched to any member(s) from the set of events. The signature set may be represented using {SIG-j}, where j=1, . . . , M. Each SIG-j specifies a compound event, which may be expressed using a logical combination of events (see “EVENTS”) that triggers the signature during event processing. If triggered, further processing may be performed by analyzing packet flow information.

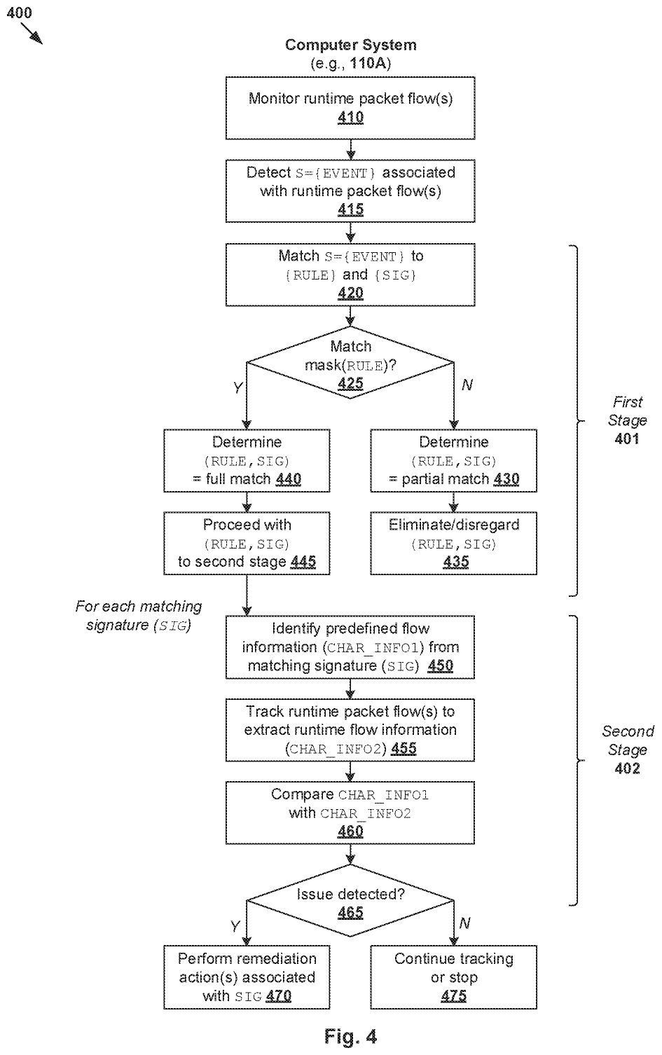

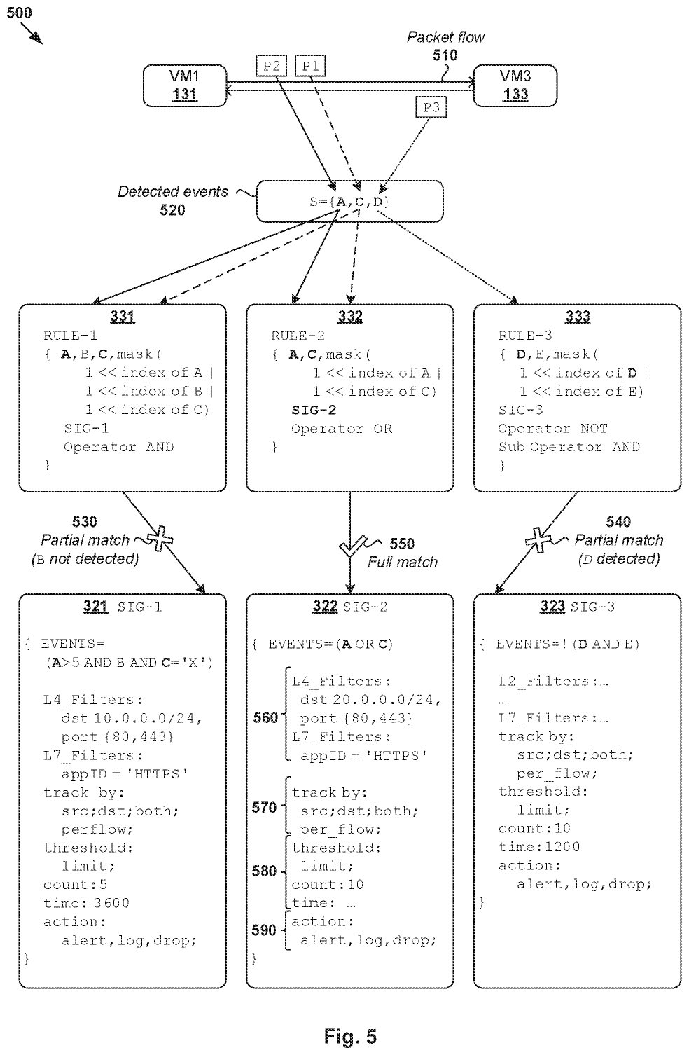

Using M=3 in FIG. 3, the set of signatures includes {SIG-1, SIG-2, SIG-3}. For example, at 321 in FIG. 3, a first signature (SIG-1) may be triggered by compound event=(A>5 AND B AND C=X). At 322, a second signature (SIG-2) may be triggered by event (A OR C). At 323, a third signature (SIG-3) may be triggered by the non-detection of both D and E (expressed as ! (D AND E), where T represents NOT). Each signature 321/322/323 also specifies pre-defined characteristic information (see “CHAR_INFO”) that may be compared against runtime characteristic information of a packet flow (to be discussed below using FIGS. 4-5).

At 330 in FIG. 3, a set of mapping rules may be configured to facilitate real time matching between event(s) 310 and signature(s) 320. A mapping rule (RULE-k where k=1, . . . , K) may specify a static mask to determine whether a corresponding compound event defined by signature (SIG-j) has occurred. During event processing, a runtime mask may be compared with the static mask defined by a mapping rule to determine whether further analysis is required during a second stage of dynamic event processing. In practice, a mapping rule may be configured to determine whether a compound event has occurred using any suitable logical operator(s), relational operator(s), etc. Example logical operators or sub-operators include AND, OR, XOR, NAND, NXOR, etc. Example relational operators include UNIQUE, CONTAINS, greater than (GT), equal to (EQ), less than (LT), etc.

For example in FIG. 3, at 331, a first mapping rule (RULE-1) may be defined using static mask=“mask(1<<index of A|1<<index of B|1 index of C)” and logical operator=AND to match three events (i.e., A, B and C) to the first signature (SIG-1). At 332, second mapping rule (RULE-2) may be defined using static mask=“mask(1<<index of A|1<<index of C)” and operator=OR to match either A or C to the second signature (SIG-2). At 333, a third rule (RULE-3) may be defined using static mask=“mask(1<<index of D|1<<index of E),” operator=NOT and sub-operator=AND in order to match the non-detection of both D and E to the third signature (SIG-3). In this case, the static masks are configured to detect whether each associated event is present or otherwise. In practice, any alternative and/or additional static masks may be configured.

Using examples of the present disclosure, analysis of network flow information may be enriched with contextual information across the lifetime of packet flow(s). The contextual information may be represented as events, and based on dynamic rules (e.g., defined by security administrators), compound event processing may be performed in real time. The example framework described herein may be implemented to enhance event processing capabilities by adding support for compound events across packet flows through suitable definition events 310, signatures 320 and mapping rules 330.

Dynamic Event Processing

According to examples of the present disclosure, mapping rules 331-333 in FIG. 3 may be used to improve the efficiency of dynamic event processing. In more detail, FIG. 4 is a flowchart of example detailed process 400 of dynamic event processing for network diagnosis. Example process 400 may include one or more operations, functions, or actions illustrated at 410 to 475. The various operations, functions or actions may be combined into fewer blocks, divided into additional blocks, and/or eliminated depending on the desired implementation. The example in FIG. 4 will be explained using FIG. 5, which is a schematic diagram illustrating first example 500 of dynamic event processing for network diagnosis.

(a) First Stage 401

At 410-415 in FIG. 4, host-A 110A may monitor runtime packet flow(s) to detect a set of events. In the example in FIG. 5, host-A 110A may monitor a runtime packet flow (see 510) between VM1 131 and VM3 133 supported by host-B 110B. In practice, runtime packet flow 510 may be initiated by either VM1 131 or VM3 133 using any suitable protocol(s). Runtime packet flow 510 may be monitored for any desirable duration and/or flow direction to detect a set of events (see 520) denoted as S=(A, C, D). As explained using FIG. 3, any suitable events A, C and D may be defined or configured. Each event may be detected based on one or multiple packets from runtime packet flow 510. For example, event C may be detected based on an egress packet (see “P1” from VM1 131), event A based on another egress packet (see “P2”) and event D based on an ingress packet (see “P3” from VM3 133).

At 420 in FIG. 4, host-A 110A may match events in S=(A, C, D) to a set of signatures based on corresponding mapping rules. In the example in FIG. 5, event A may be matched to SIG-1 (see 321) and SIG-2 (see 322) based on respective RULE-1 (see 331) and RULE-2 (see 332). Similarly, event C may be matched to SIG-1 (see 321) and SIG-2 (see 322) based on respective RULE-1 (see 331) and RULE-2 (see 332). Event D may be matched to SIG-3 (see 323) based on RULE-3 (see 333). As such, one runtime packet flow 510 may trigger multiple rules 331-333 and signatures 321-323.

At 425-430 in FIG. 4, host-A 110A may examine each mapping rule to determine whether the corresponding signature is a full match (e.g., compound event has occurred) or partial match (e.g., compound event has not occurred or partially occurred). If there is a partial match, the mapping rule and signature may be eliminated or disregarded at block 435. For example in FIG. 5, at 530, RULE-1 (see 331) is not fully satisfied because event B has not been detected and SIG-1 (see 321) requires the detection of a compound event that includes three events (A, B, C). As such, based on RULE-1 (see 331), SIG-1 (see 321) may be identified to be a partial match and eliminated from further consideration. Similarly, at 540, RULE-3 (see 333) is not fully satisfied because SIG-3 (see 323) requires the non-detection of events (D, E). Since D has been detected, SIG-3 may be disregarded.

In contrast, at 550 in FIG. 5, RULE-2 (see 332) is fully satisfied based on the detection of event A or C. Corresponding signature=SIG-2 (see 322) may be considered further during a second stage of dynamic event processing. Using mapping rules 331-333, events in S=(A, C, D) may be matched to SIG-2 (see 322) in a more efficient manner. See corresponding blocks 425 (yes), 440 and 445.

Depending on the desired implementation, block 425 may involve marking a runtime mask to represent whether events are detected, such as (1, 0, 1, 1, 0) for events (A, C, D), where index=1 for EVENT-1=A, index=3 for EVENT-3=C and index=4 for EVENT-4=D. The runtime mask may then be compared with a static mask defined using “mask( )” for each rule in FIG. 3 to determine whether there is a full or partial match. This way, partial signature matches may be eliminated as early as possible during the first stage of event processing, more CPU resources may be dedicated to the second stage below.

(b) Second Stage 402

At 450, 455 and 460 in FIG. 4, runtime characteristic information (labelled “CHAR_INFO2”) captured from runtime packet flow(s) 510 may be compared against predefined characteristic information (labelled “CHAR_INFO1”) specified by each matching signature. Block 455 may involve tracking runtime packet flow(s) 510 to extract the necessary runtime characteristic information based on the matching signature. To facilitate the comparison, signature=SIG-2 (see 322) may specify various properties, such as “filter” (see 560); “track by” (see 570); “threshold,” “limit” and “time” (see 580) and “action” (see 590).

In more detail, at 560, a “filter” property may be configured to specify various filters for filtering access control (MAC) information, network layer information, transport layer information and application layer information. Layer-4 filters may specify attributes such as source IP address, destination IP address, source port number and destination port number. Layer-7 filter may specify attributes such as application ID, protocol, etc. This way, a particular signature may be matched against events or attributes from different layers from the networking stack. At 570, a “track by” property may be configured to instruct host-A 110A to track runtime packet flow(s) 510, such at a source, destination, both source and destination, per-flow basis, etc. At 580, a “threshold,” “limit,” “count” and “time” properties may be configured to specify a minimum threshold, maximum threshold, counter and duration, respectively.

At 465-470 in FIG. 4, in response to detecting or diagnosing an issue based on the comparison, host-A 110A may perform remediation action(s) associated with the matching signature=SIG-2 (see 322). In the example in FIG. 5, an action property (see 590) may be configured to specify remediation action(s) to be taken, such as “drop” to drop packet(s), “alert” to generate and send an alert to a user (e.g., network administrator) and “log” to generate and store log information. Another possible remediation action is to “execute” a script to address the issue in an automated manner. The script may be launched with relevant parameters to, for example, configure a firewall rule or bring an affected port down.

Although explained using three mapping rules 331-333 and signatures 321-323 in FIG. 5, it should be understood that any suitable mapping rules may be defined. For example, a mapping rule may be defined as a logical combination of simple and/or complex events. Example simple events may include port scan event (e.g., UNIQUE destination port count>100, threshold=10 minutes); dictionary attack (e.g., login failure count>10, threshold=1 minute); brute force attack (secure socket layer (SSL) incomplete negotiation count>10, threshold=1 Min), etc.

More complex events may include: port-to-APP-ID mismatch (e.g., destination port==80, and APP ID!=HTTP), number of drop rule hits within one period (e.g., (L4 Drop>10000) II (L7 Drop>100) per destination, threshold=10 seconds; logins per second with small transactions (e.g., SQL.Transaction<3 and Login.Username is UNIQUE, Threshold Count 10, 10 seconds); high rate of mini flows (e.g., packet count per flow<20, per source/destination, threshold count=100, 10 seconds).

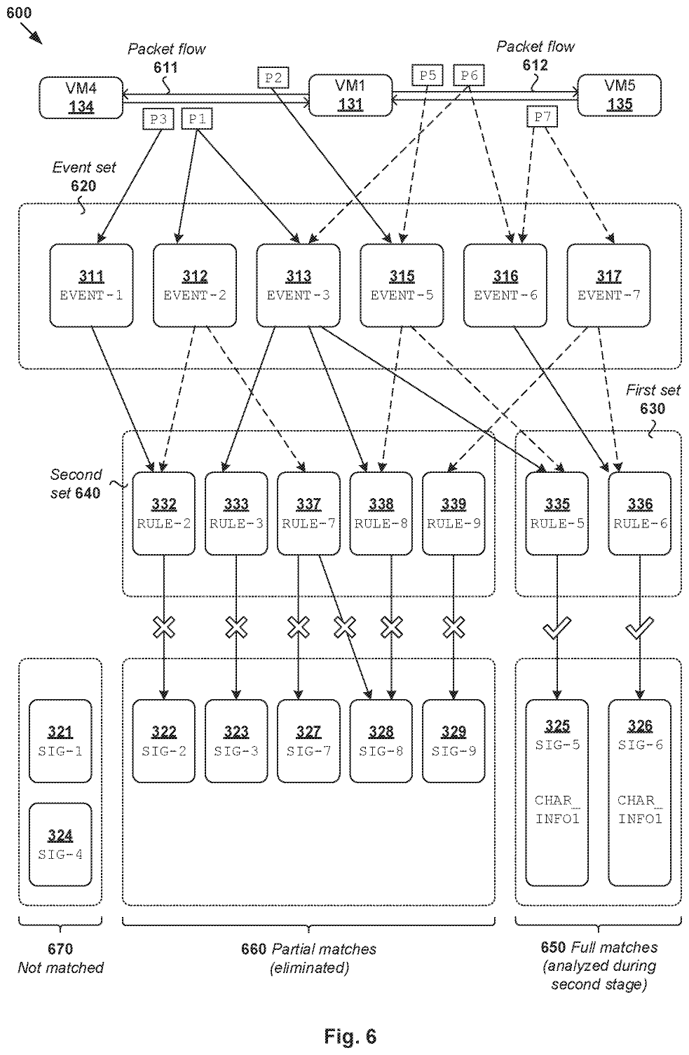

According to examples of the present disclosure, any suitable mapping rules may be configured to detect compound events of different complexities from any suitable number of packet flows. Additional examples are shown in FIG. 6, which is a schematic diagram illustrating second example 600 of dynamic event processing for network diagnosis. In this example, host-A 110A may monitor multiple packet flows, including first flow 611 between VM1 131 and VM4 134 and a second flow 612 between VM1 131 and VM5 135. Based on flows 611-612, host-A 110A may detect a set of events (see 620) that includes (EVENT-1 311, EVENT-2 312, EVENT-3 313, EVENT-5 315, EVENT-6 316, EVENT-7 317).

During a first stage of event processing, host-A 110A may identify a first set of mapping rules (see 630 in FIG. 6) that are each fully satisfied by the set of events, including (RULE-5 335, RULE-6 336). First mapping rule set 630 may be matched to first signatures=(SIG-5 325, SIG-6 326) that may be analyzed further below. Further, host-A 110A may also identify a second set of mapping rules (see 640 in FIG. 6) that is partially satisfied by the set of events, including (RULE-2 332, RULE-3 333, RULE-7 337, RULE-8 338, RULE-9 339). Second set 640 may be matched to second signatures=(SIG-2 322, SIG-3 323, SIG-7 327, SIG-8 328, SIG-9 329), which may be disregarded during the second stage below. See 650 (full matches) and 660 (partial matches) and 670 (no matches).

During a second stage of event processing, first signatures=(SIG-5 325, SIG-6 326) may be analyzed further. This stage is generally more resource-intensive and involves comparing (a) predefined characteristic information specified by SIG-5 325 and SIG-6 326 and (b) runtime characteristic information associated with runtime flows 611-612. In practice, flows 611-612 may be tracked for a period of time to identify any potential issues for network diagnosis purposes. Since corresponding (RULE-5 335, RULE-6 336) may be configured to define any suitable compound events, examples of the present disclosure may be implemented to facilitate dynamic compound event processing. This way, hosts 110A-C may perform event processing in a more efficient and reactive manner compared to conventional approaches that necessitates event processing by a remote entity (i.e., not by hosts 110A-C).

Container Implementation

Although explained using VMs, it should be understood that SDN environment 100 may include other virtual workloads, such as containers, etc. As used herein, the term “container” (also known as “container instance”) is used generally to describe an application that is encapsulated with all its dependencies (e.g., binaries, libraries, etc.). In the examples in FIG. 1 to FIG. 6, container technologies may be used to run various containers inside respective VMs. Containers are “OS-less”, meaning that they do not include any OS that could weigh 10s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies. The containers may be executed as isolated processes inside respective VMs.

Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform process(es) described herein with reference to FIG. 1 to FIG. 6. For example, the instructions or program code, when executed by the processor of the computer system, may cause the processor to perform examples of the present disclosure.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

1. A method for a computer system to perform dynamic event processing for network diagnosis, wherein the method comprises:
monitoring a runtime flow of multiple packets that originate from, or destined for, a virtualized computing instance supported by the computer system to detect a set of multiple events associated with the runtime flow;
performing a first stage of event processing by matching the set of multiple events to a set of multiple signatures that includes:
(a) a first signature associated with a first mapping rule that is fully satisfied by the set of multiple events; and
(b) a second signature associated with a second mapping rule that is partially satisfied by the set of multiple events;
performing a second stage of event processing by comparing predefined characteristic information specified the first signature against runtime characteristic information associated with the runtime flow, wherein the second signature is disregarded during the second stage of event processing; and
in response to diagnosing an issue associated with the runtime flow based on the second stage of event processing, performing one or more remediation actions.

2. The method of claim 1, wherein performing the first stage of event processing comprises:
matching the set of multiple events to the first mapping rule to determine whether a first compound event has occurred, wherein the first mapping rule specifies the first compound event as a logical combination of at least two events.

3. The method of claim 2, wherein performing the first stage of event processing comprises:
in response to determination that the first compound event has occurred, determining that the first mapping rule is fully satisfied by the set of the multiple events.

4. The method of claim 3, wherein performing the second stage of event processing comprises:
comparing the predefined characteristic information associated with the first compound event against the runtime characteristic information associated with the runtime flow.

5. The method of claim 3, wherein performing the first stage of event processing comprises:
identifying the predefined characteristic information that is specified by the first signature and includes at least one of the following: medium access control (MAC) information, network layer information, transport layer information and application layer information.

6. The method of claim 1, wherein performing the first stage of event processing comprises:
matching the set of multiple events to the second mapping rule to determine whether a second compound event has occurred, wherein the second mapping rule specifies the second compound event as a logical combination of at least two events.

7. The method of claim 6, wherein the method further comprises:
in response to determination that the second compound event has not occurred or partially occurred, determining that the second mapping rule is not fully satisfied.

8. A non-transitory computer-readable storage medium that includes a set of instructions which, in response to execution by a processor of a computer system, cause the processor to perform dynamic event processing for network diagnosis, wherein the method comprises:
monitoring a runtime flow of multiple packets that originate from, or destined for, a virtualized computing instance supported by the computer system to detect a set of multiple events associated with the runtime flow;
performing a first stage of event processing by matching the set of multiple events to a set of multiple signatures that includes:
(a) a first signature associated with a first mapping rule that is fully satisfied by the set of multiple events; and
(b) a second signature associated with a second mapping rule that is partially satisfied by the set of multiple events;
performing a second stage of event processing by comparing predefined characteristic information specified the first signature against runtime characteristic information associated with the runtime flow, wherein the second signature is disregarded during the second stage of event processing; and
in response to diagnosing an issue associated with the runtime flow based on the second stage of event processing, performing one or more remediation actions.

9. The non-transitory computer-readable storage medium of claim 8, wherein performing the first stage of event processing comprises:
matching the set of multiple events to the first mapping rule to determine whether a first compound event has occurred, wherein the first mapping rule specifies the first compound event as a logical combination of at least two events.

10. The non-transitory computer-readable storage medium of claim 9, wherein performing the first stage of event processing comprises:
in response to determination that the first compound event has occurred, determining that the first mapping rule is fully satisfied by the set of the multiple events.

11. The non-transitory computer-readable storage medium of claim 10, wherein performing the second stage of event processing comprises:
comparing the predefined characteristic information associated with the first compound event against the runtime characteristic information associated with the runtime flow.

12. The non-transitory computer-readable storage medium of claim 10, wherein performing the first stage of event processing comprises:
identifying the predefined characteristic information that is specified by the first signature and includes at least one of the following: medium access control (MAC) information, network layer information, transport layer information and application layer information.

13. The non-transitory computer-readable storage medium of claim 8, wherein performing the first stage of event processing comprises:
matching the set of multiple events to the second mapping rule to determine whether a second compound event has occurred, wherein the second mapping rule specifies the second compound event as a logical combination of at least two events.

14. The non-transitory computer-readable storage medium of claim 13, wherein the method further comprises:
in response to determination that the second compound event has not occurred or partially occurred, determining that the second mapping rule is not fully satisfied.

15. A computer system, comprising:
a processor; and
a non-transitory computer-readable medium having stored thereon instructions that, when executed by the processor, cause the processor to perform the following:
monitor a runtime flow of multiple packets that originate from, or destined for, a virtualized computing instance supported by the computer system to detect a set of multiple events associated with the runtime flow;
perform a first stage of event processing by matching the set of multiple events to a set of multiple signatures that includes:
(a) a first signature associated with a first mapping rule that is fully satisfied by the set of multiple events; and
(b) a second signature associated with a second mapping rule that is partially satisfied by the set of multiple events;
perform a second stage of event processing by comparing predefined characteristic information specified the first signature against runtime characteristic information associated with the runtime flow, wherein the second signature is disregarded during the second stage of event processing; and
in response to diagnosing an issue associated with the runtime flow based on the second stage of event processing, perform one or more remediation actions.

16. The computer system of claim 15, wherein the instructions for performing the first stage of event processing cause the processor to:
match the set of multiple events to the first mapping rule to determine whether a first compound event has occurred, wherein the first mapping rule specifies the first compound event as a logical combination of at least two events.

17. The computer system of claim 16, wherein the instructions for performing the first stage of event processing cause the processor to:
in response to determination that the first compound event has occurred, determine that the first mapping rule is fully satisfied by the set of the multiple events.

18. The computer system of claim 17, wherein the instructions for performing the second stage of event processing cause the processor to:
compare the predefined characteristic information associated with the first compound event against the runtime characteristic information associated with the runtime flow.

19. The computer system of claim 17, wherein the instructions for wherein performing the first stage of event processing cause the processor to:
identify the predefined characteristic information that is specified by the first signature and includes at least one of the following: medium access control (MAC) information, network layer information, transport layer information and application layer information.

20. The computer system of claim 15, wherein the instructions for performing the first stage of event processing cause the processor to:
match the set of multiple events to the second mapping rule to determine whether a second compound event has occurred, wherein the second mapping rule specifies the second compound event as a logical combination of at least two events.

21. The computer system of claim 20, wherein the instructions for performing the first stage of event processing cause the processor to:
in response to determination that the second compound event has not occurred or partially occurred, determine that the second mapping rule is not fully satisfied.
